(19) United States
(12) Patent Application Publication
(10) Pub. No.: US 2017/0144007 A1
(43) Pub. Date: May 25, 2017

(54) Transportable holding apparatus for fast-flow high-pressure liquid spraying devices

(71) Applicant: Mirian Denise Kelley, Sugar Land, TX (US)

(72) Inventor: Mirian Denise Kelley, Sugar Land, TX (US)

(21) Appl. No.: 14/951,631

(22) Filed: Nov. 25, 2015

(51) Int. Cl. A62C 33/04

(52) U.S. Cl. CPC A62C 33/04

(57) ABSTRACT

A multipurpose transportable holding apparatus to grip securely a fast-flow high-pressure liquid spraying device e.g. fire fighter's fast-flow high-pressure water hose. The holding apparatus supplements the intense control and strength needed to commandeer command and safely operate fast-flow high-pressure liquid spraying devices unaided while in use for extended periods of time. The apparatus can be considered the twelfth person of an eleven member team during an elongated laborious exhausting and hazardous campaign requiring significant physical strength and intense exertion e.g. fighting fires or pressure washing in unsafe and hazardous environments. The torque absorbing holding apparatus holds steady and secure a fast-flow high-pressure liquid spraying device providing consistent uniform application and enforcement for the spraying device without compromise.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

Field of the Invention

This invention pertains to USPTO Cooperative Patent Classification (CPC) ‘B’—performing operations, transporting; B25B—tools or bench devices not otherwise provided for, for fastening, connecting, disengaging or holding; B05B—spraying apparatus; B27G—accessory machines or apparatus, tools, safety devices e.g. those for saws.

All listed prior art found does not address the functionality to restrain or hold a fast-flow high-pressure spraying device similar to this invention. Below is a list of some of the prior art found:
20150298297 Clamping Method & Apparatus B25B 1/24
20150266165 Clamp Head B25B 5/16; 5/10
20150252855 Torque Limiting Device B25B 23/1427; A61B
20150246430 Clamping Assembly B25B 5/06; B25J 15/008
20150202699 Apparatus for Manipulating Tubular and Round Section Objects
20150183093 Apparatus & Method for Mechanical Vice
20150174738 Bar Clamp & Bar Clamp Assembly B25B 5/102; 5/103
20150151392 Clamp Apparatus
20150137440 Clamp Apparatus B25B 5/08; 1/04
20150101463 Apparatus for Holding and Applying Torque to a Nut B25B 23/108; 13/54
20150054210 Centric Clamping Vice B25B 1/02; 1/103
20150053053 Torque Limiting Tool and Method for Using Same B25B 23/1415
20150042027 Clamp B25B 1/20
20140353898 Clamping Device, particularly a clamping module B25B 1/18; B23Q 1/262; 1/44
20140346725 Portable Work Holding Device and Assembly B25B 1/2484; 1/02; B60R 11/00

The apparatus is designed to hold securely a fast-flow high-pressure liquid spraying device e.g. fire fighter's fast-flow high-pressure water hose. The apparatus is intended to supplement the intense control and strength needed to commandeer command and safely operate such devices while in use for extended periods of time.

The constant and continual demand to grasp, hold on to and control a fast-flow high-pressure flexible liquid spraying device e.g. a fast-flow high-pressure washing hose can be exhausting and hazardous during an elongated laborious operation requiring significant physical strength and intense exertion that can possibly create productivity gaps and safety risks during critical campaigns.

Therefore, it is desirable to develop a transportable torque (pressure) absorbing holding apparatus that acts as an additional resource to hold steady and secure a fast-flow high-pressure liquid spraying device without compromise.

### BRIEF SUMMARY OF THE INVENTION

Briefly described, one aspect of the present disclosure provides an apparatus designed to securely hold a fast-flow high-pressure liquid spraying device e.g. fire fighter's fast-flow high-pressure water hose during high impact, high pressurized liquid spraying operations. The device includes a handle that is ergonomically shaped to enable the apparatus to be grasped easily and comfortably by an individual for easy movement and set-up.

To provide an effortless portable experience, the transportable holding apparatus collapses into a near flat mechanism utilizing two wheels attached to the base back cross bar for easy navigation and maximum maneuverability. Opposite the base back cross bar of the device attached to the base bar is the ergonomically shaped handle positioned between the two front legs which are positioned and shaped for maximum balance and sturdiness to provide the apparatus stability during operations. A heavy duty cross body strap is used to wrap around the transportable holding apparatus when folded into a near flat position for additional safety precautions during transport and storage.

The transportable holding apparatus is designed to securely hold and immobilize a fast-flow high-pressure liquid spraying device e.g. fire fighter's fast-flow high-pressure water hose using a holding clamp harness with elongated neck inserted into the forward cylinder to absorb torque generated by the force of the liquid spraying device during start-up and operations. The transportable holding apparatus can be used to grasp and immobilize, hold on to and maintain the direction and position of a spraying device of any size, even though the design is targeted for the high power, high pressurized, fast flow liquid spraying devices which require substantial strength to manage and maneuver for significant periods of time and in hostile environments e.g. firefighting of all natures, wildfires in hazardous terrains, environmental cleaning and separation operations, pressure washing and cleaning of chemicals, oil & gas holding tanks, etc.

The transportable holding apparatus' horizontal forward cylinder is adjustable. The horizontal forward cylinder releases, lifts and locks at various angles via its cylindrical rollers attached to the base bar of the apparatus. For additional stability, the horizontal forward cylinder is reinforced and supported by a concave intersection in which the back support cylinder locks into place at the mid-section of the horizontal forward cylinder. The cylinder rollers attached to both the horizontal forward cylinder and back support cylinder allow the transportable holding apparatus to be folded flat or positioned at an appropriate angle to achieve the desired liquid spraying arc. The horizontal forward cylinder's hollow cavity contains internal shafts that support elevation of the spraying device to achieve and support the desired liquid flow arc. After the desired height and direction is attained, the holding clamp harness is secured in place using the horizontal forward cylinder spring key and lock.

The holding clamp (harness) which contains a soft flexible inner lining attaches directly to the upper neck of the outer wall of the liquid spraying device closest to the head, opening or nozzle and is tightened securely in place. The holding clamp harness' outer wall is designed to overlap creating an alignment of its apertures to form a secure jacket engulfing the liquid spraying device snugly but allowing leniency in the grasp to accommodate for friction. The holding clamp (harness) apertures are securely clasped via fasteners. The elongated clamp rod of the holding clamp (harness) is inserted into the internal shaft of the forward cylinder and positioned toward the target using the directional panning plate. The apparatus is designed to be an additional resource much like that of the ‘12^{th} man theory’ for an eleven-a-side sports game team e.g. American football.

Attached to the horizontal forward cylinder can be a light kit which raises, lowers and turns 360 degrees. The light is attached via heavy duty strap and closure.

Numerous other aspects, features, and advantages of the present invention will be made apparent from the following detailed description together with the drawings and figures.

### BRIEF DESCRIPTION OF THE SEVERAL VIEWS OF THE DRAWINGS

The drawings illustrate the best mode currently contemplated of practicing the present disclosure. The drawings:

FIG. 1 is an overall view of the one embodiment of a transportable holding apparatus constructed according to the present disclosure;

FIG. 2 is a side view of the one embodiment of a transportable holding apparatus with wheels, forward and back cylinders, and locking mechanisms constructed according to the present disclosure;

FIG. 3 is a side view of the one embodiment of a transportable holding apparatus with brace plates constructed according to the present disclosure;

FIG. 4 is a side view of the one embodiment of a transportable holding apparatus showing where various members of the apparatus are attached to each other constructed according to the present disclosure;

FIG. 5 is an overall view of the transportable holding apparatus of FIG. 1 holding a fast-flow high-pressure liquid spraying device e.g. fire fighter's fast-flow high-pressure water hose;

FIG. 6 is a side view of the apparatus of FIG. 1 in a collapsed (folded) vertical and horizontal perspective bound by heavy duty safety belts.

### DETAILED DESCRIPTION OF THE INVENTION

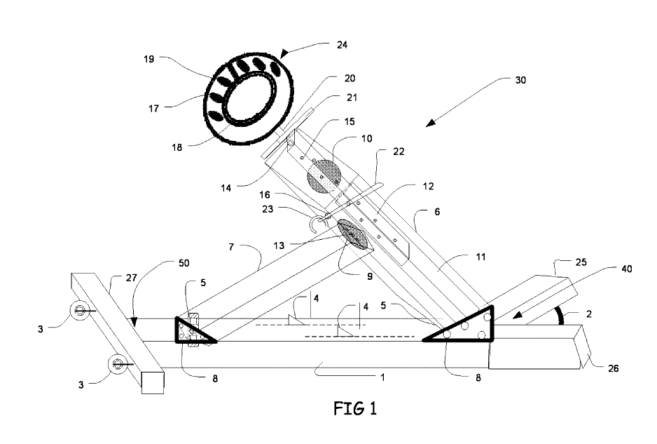

Referring now in detail to the drawing figures, wherein like reference numerals represent like parts throughout the several views, one embodiment of a apparatus constructed according to the present disclosure is illustrated generally in FIG. 1. The apparatus 30 in the illustrated embodiment is a rigid frame formed of a length of a suitable durable material, such as metal, among others beginning with an elongate base bar 1 adapted to rest upon a level surface wherein said base bar 1 is perpendicularly attached at one end, the rear side 50, to the mid-section of the base back cross bar 27 and at the opposite end of base bar 1, the front side 40 includes two legs at a sufficient angle, the left leg 26 and right leg 25 is of equal length. The elongated base bar 1 comprises a front side 40 and a rear side 50. Between the base bar right leg 25 and base bar left leg 26 is an ergonomically designed handle 2. The handle 2 can be formed of any suitable material, such as a metal, plastic or wood capable of enabling the apparatus 30 to be transportable in its intended manner. Additionally, the handle 2 can have any desired axial and/or cross-sectional shape suitable for the intended purpose of the apparatus 30. The handle 2 can also include any suitable structure (not shown), such as including finger wedge or grip (not shown) that assists the user in retaining a grasp on the handle 2. The finger wedge or grip is formed of any conventional grip material, such as leather or foamed materials, among others, in order to provide additional comfort to the hand of the individual grasping the handle 2 in addition to that afforded by the shape of the handle 2. In the illustrated embodiment, the handle 2 has an ergonomic shape, which can be shaped in an arc similar to a handle used for a cross bow.

Further, in the illustrated embodiment, extending from the rear of the base back cross bar 27 are wheels 3 generally spaced from either end of the base back cross bar 27 which makes contact with the ground or floor surface when the apparatus 30 is lifted upward or to a horizontal position for transport maneuverability. Attached to base bar 1 at the front side 40 and rear side 50 of the elongated pedestal is a set of cylinder rollers 5 which allows the rigid forward horizontal cylinder 6 and back support cylinder 7 to rotate up and down when the brace plates 8 are not in a permanent or locked position. On the upward facing side of base bar 1 are two locking portions 4 which interconnect the horizontal forward cylinder 6 and back support cylinder 7 to the base bar 1 when the apparatus 30 is folded for transport or storage. The locking portion 4 can be any suitable mechanism capable of securely engaging and alternatively releasing the forward horizontal cylinder 6 and back support cylinder 7 to and from the base bar 1. The locking members (not shown) on the horizontal forward cylinder 6 and back support cylinder 7 are capable of being engaged by the locking portion 4 to be secured to base bar 1. In the illustrated embodiment, the locking portion 4 on base bar 1 inserts into ridges of the locking members (not shown). In addition, the locking members (not shown) can be formed integrally with the horizontal forward cylinder 6 and back support cylinder 7 or can be attached thereto.

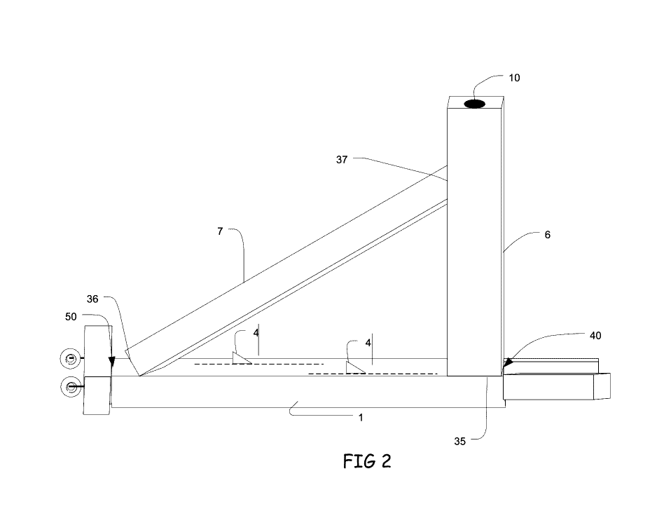

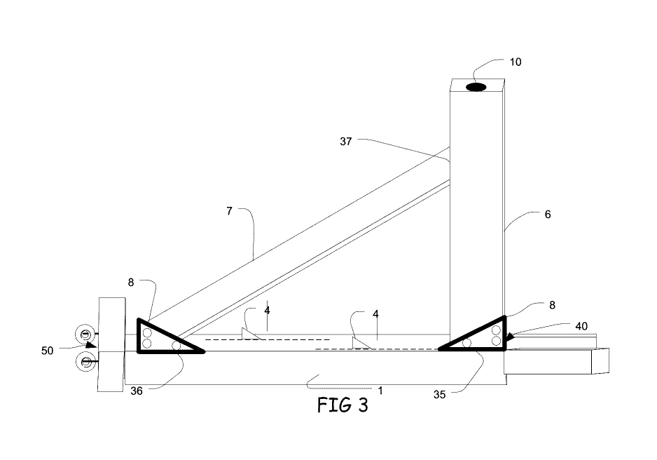

Now referring to FIGS. 2 and 3, in the illustrated embodiment is a generally forward horizontal cylinder 6 extends upwards whereby the forward horizontal cylinder 6 is attached to the upward facing side of base bar 1 at the front side 40 of the elongated base bar 1 at 35. A back support cylinder 7 extends upwards and comprises an elongated cylinder having opposing ends generally fixed perpendicularly to the midpoint of the forward horizontal cylinder 6 at one end 37 and at the rear side 50 of the elongated base bar 1 at the other end 36. A brace plate 8 is attached on the right and left sides of the forward horizontal cylinder 6 of the elongated base bar 1 at the front side 40. A brace plate 8 is attached on the right and left sides of the back support cylinder 7 of the elongated base bar 1 at the rear side 50 at 36.

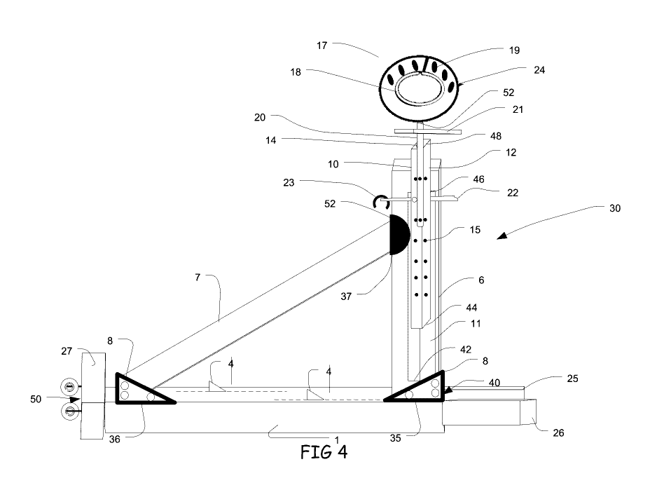

Now referring to FIG. 4, the forward horizontal cylinder 6 is cavernous to include two internal shafts, an upper 12 and lower 11 both comprising rigid material. The upper internal shaft 12 is of a narrower diameter than the lower internal shaft 11 whereby the upper internal shaft 12 fits inside the hollow shell of the lower internal shaft 11 and extends up and down. The lower internal shaft 11 having one end 42 securely fixed to the bottom of the forward horizontal cylinder 6 whereby the opposite upper end 46 of the lower internal shaft 11 is the opening receptacle for the upper internal shaft's lower end 44. The upper internal shaft 12 is generally sprinkled with through holes 15 throughout its body while only the upper half of the lower internal shaft 11 contains through holes 15 to lock the internal shaft height. Top center of the forward horizontal cylinder 6 is the forward cylinder top through aperture 10 which allows the neck of the upper internal shaft 12 to be extended up and beyond the cavity of the forward horizontal cylinder 6. Situated at the upper end 48 of the upper internal shaft 12 is a winding connection 14 to receive and hold the holding clamp 24 in place in the cavity of the forward horizontal cylinder 6.

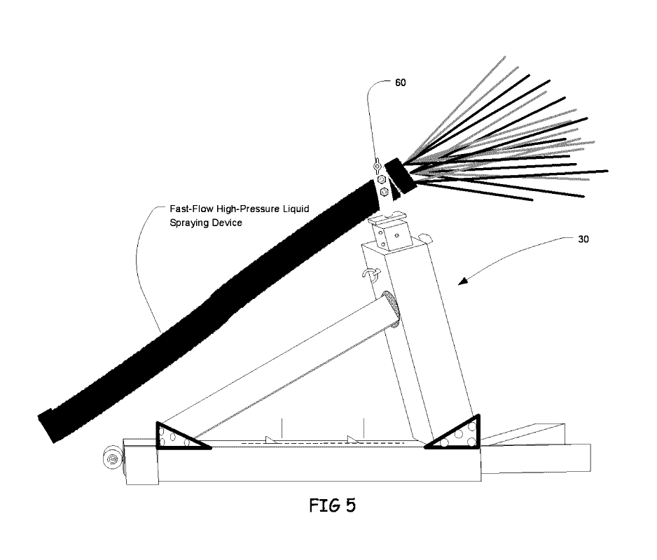

In the illustrated embodiment, the holding clamp 24 is supported by an elongate clamp rod 20 formed of a suitable length of a durable rigid material, such as metal or plastic, among others. The holding clamp 24 and elongate clamp rod 20 is secured as one in a suitable manner using any suitable securing or fixation member, such as a pin or a screw. In the illustrated embodiment, the holding clamp 24 is secured to elongate clamp rod 20 using a screw (not shown) as the securing member. The elongate clamp rod 20 raises and lowers via the winding connection 14 at the upper end 48 of the upper internal shaft 12. A vertically disposed holding clamp 24 circular in shape when generally attached is secured at the upper end 52 of the elongate clamp rod 20. The vertically disposed holding clamp 24 includes an inner layer, the inner clamp gripping harness 18 comprising a soft suitable material which includes but is not limited to foam covered with vinyl or other materials and an outer member 17 comprising semi-flexible rigid materials such as metal or plastic, among others. The inner clamp gripping harness 18 is made of materials that will not scratch, puncture or damage and will swathe the outer wall of the fast-flow high-pressure spraying device when pressure is applied against the harness. To facilitate the engagement of the outer member 17 with the inner clamp gripping harness 18 both have a number of apertures 19 disposed along the length of the outer member 17 and the inner clamp gripping harness 18. The outer member 17 apertures 19 adjusts to align with apertures 19 of the inner clamp gripping harness 18 to create a secure restraint for the fast-flow high-pressure spraying device secured in a suitable manner using any suitable securing or fixation member, such as a pin, bolt or a screw. In the illustrated embodiment, the holding clamp 24 is secured to the fast-flow high-pressure spraying device using a bolt 60 (see FIG. 5) as the securing member.

The panning plate 21 comprising rigid materials such as metal or plastic, among others is attached at the upper end 52 of the elongate clamp rod 20. The panning plate 21 allows the user to easily make minor adjustments by swiveling the panning plate 21 to the right or left to make height and direction changes to the holding clamp 24. The elongate clamp rod 20 is locked into place by inserting the spring key 22 through the forward horizontal cylinder 6 front through hole (not shown) encompassing the upper internal shaft 12, the elongate clamp rod 20 and the lower internal shaft 11 continuing through the forward horizontal cylinder 6 back through hole (not shown). The spring key 22 is fortified by attaching the spring key hook 23. The spring key 22 and spring key hook 23 comprising rigid materials such as metal or plastic, among others. In the shown preferred embodiment, the rigid frame with a base bar 1 adapted to rest upon a level surface, such as a floor or ground, base back cross bar 27, left leg 26 and right leg 25 include suitable nonskid material (not shown) such as rubber but not limited to rubber applied to the bottom of each member providing firm grip once the frame is at rest.

In operation, as FIG. 5 illustrates the apparatus 30 with vertically disposed holding clamp 24 in a closed position thereby securely embracing and holding a fast-flow high-pressure liquid spraying device such as a fireman's water hose. The fast-flow high-pressure liquid spraying device is restrained from moving forward beyond the forward horizontal cylinder 6 and is secure in the direction in which the user prefers the flow of liquid to remain constant and consistent.

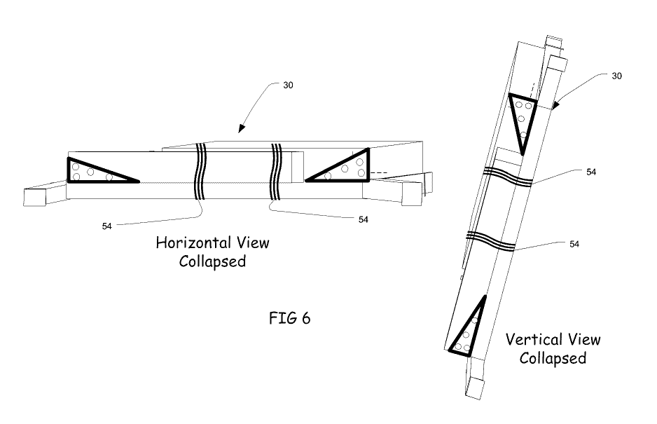

FIG. 6 illustrates the apparatus 30 folded and lying flat horizontally on a level surface and upright vertically prepared for transport with heavy duty belt 54 securing its parts as an added safety precaution.

Various other embodiments of the present invention are contemplated as being within the scope of the filed claims particularly pointing out and distinctly claiming the subject matter regarded as the invention.

While preferred embodiments have been shown and described, it will be understood that it is not intended to limit the disclosure, but rather is intended to cover all modifications and alternate methods and apparatus within the spirit and scope of the invention as defined in the claims.

1. A holding apparatus comprising:
A ‘T’ shaped rigid frame connected to a ‘v’ shaped rigid frame at the intersecting angle of the ‘v’ comprising a base to rest upon a floor or level ground surface, said base comprising a pair of vertical cylinders, one forward and one rear, extending upward from the base, said ‘v’ shaped legs contains a grasping handle situated between the two,
said pair of vertical cylinders each having a left side and a right side, said pair of vertical cylinders each having a front side and a rear side, generally perpendicularly fixed to the base at opposite ends, where one cylinder comprises an elongated bar having opposing ends generally perpendicularly fixed to the midpoint of the said other cylinder at one end and at the midpoint of the said back bar at the opposite end of the base, said left and right sides of the vertical cylinders are generally supported by a rigid brace plate fixed to the cylinders along the vertical and horizontal planes of the plate to the cylinders,
a cylinder is cavernous to include two internal shafts one of a narrower diameter than the other whereby said shaft fits inside the hollow shell of the other and extends up and down, said shaft having one end securely fixed to the bottom of a cylinder whereby the opposite upper end of the lower shaft being the entryway for the other shaft's lower end, said upper shaft being generally sprinkled with holes along its body while only the upper half of the said second shaft contains holes,
a vertically disposed holding clamp comprising an inner layer, the inner clamp gripping harness comprising a soft suitable material and an outer member comprising semi-flexible rigid materials,
an elongate clamp rod comprising a rigid frame,
a panning plate selectively attached to said elongate clamp rod to allow a fast-flow high-pressure liquid spraying device to be fastened in a general position during operations.

2. The holding apparatus according to claim 1 wherein said horizontal base including a pair of vertically disposed cylinders, one which further including a pair of opposing ends, wherein a first vertically disposed bar first opposing end is secured to the mid-section of the other vertically disposed cylinder and said second opposing end is secured to said base, said second vertically disposed cylinder having inner members and an outer member whereby said shafts allows upward movement of the holding clamp to manage the force, restrain the direction and height of the spraying device during operations by gripping and holding the device securely.

3. The holding apparatus according to claim 1 wherein said holding clamp includes a means for attachment to said cylinder at said peak.
